(19) United States
(12) Patent Application Publication
(10) Pub. No.: US 2012/0136801 A1
(43) Pub. Date: May 31, 2012

(54) Method Of Manufacturing Hot-Runner System

(75) Inventors: Keith Carlton, Caledon (CA); Dinesh Budapanahalli, Pebble Bay (SG); Gerardo Chiaia, Shanghai (CN)

(73) Assignee: HUSKY INJECTION MOLDING SYSTEMS LTD., Bolton, ON (CA)

(21) Appl. No.: 13/384,809

(22) PCT Filed: Jul. 30, 2010
(86) PCT No.: PCT/US10/43900

§ 371 Date: Jan. 19, 2012

(30) Foreign Application Priority Data
Aug. 7, 2009 (US) 61232042

(51) Int. Cl. G06Q 50/28

(52) U.S. Cl. 705/330

(57) ABSTRACT

Disclosed is a method (100) of manufacturing a hot-runner system. The method (100) includes: a shipping operation (106), including shipping a partially constructed hot-runner component to a business entity, the business entity to build, at least in part, the hot-runner system using the partially constructed hot-runner component, the business entity to ship the hot-runner system to an end user, and the end user to use the hot-runner system in a molding system, the partially-completed hot-runner component being manufactured, at least in part, based on engineering data related to the partially-completed hot-runner component, and the engineering data being prepared, at least in part, the engineering data being related to the partially-completed hot-runner component, the partially-completed hot-runner component to be used in the hot-runner system.

### TECHNICAL FIELD

An aspect of the present invention generally relates to (by example, but is not limited to) a method of manufacturing a hot-runner system, the hot-runner system to be used in a molding system.

The aspects are described in the independent claims.

### BACKGROUND OF THE INVENTION

It is known that a vendor entity manufactures hot-runner systems, which are shipped to end users who then place them into molding systems.

### SUMMARY OF THE INVENTION

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of the instant patent application.

According to one aspect, there is provided a method (100) of manufacturing a hot-runner system, including (but not limited to): a shipping operation (106), including shipping a partially constructed hot-runner component to a business entity, the business entity to build, at least in part, the hot-runner system using the partially constructed hot-runner component, the business entity to ship the hot-runner system to an end user, and the end user to use the hot-runner system in a molding system, the partially-completed hot-runner component being manufactured, at least in part, based on engineering data related to the partially-completed hot-runner component, and the engineering data being prepared, at least in part, the engineering data being related to the partially-completed hot-runner component (such as, a partially constructed manifold assembly), the partially-completed hot-runner component to be used in the hot-runner system.

According to another aspect, there is provided a method (300) of manufacturing a hot-runner system, including (but not limited to): a shipping operation (306), including: shipping a standard hot-runner component and engineering data to a business entity, the engineering data being prepared is related to the hot-runner system, a standard hot-runner component being prepared is to be used in the hot-runner system, the business entity is to use the standard hot-runner component and the engineering data to build the hot-runner assembly, the business entity is to ship the hot-runner system to an end user of the hot-runner system, the end user is to use the hot-runner system in a molding system.

Other aspects and features of the non-limiting embodiments will now become apparent to those skilled in the art upon review of the following detailed description of the non-limiting embodiments with the accompanying drawings.

### BRIEF DESCRIPTION OF THE DRAWINGS

The non-limiting embodiments will be more fully appreciated by reference to the following detailed description of the non-limiting embodiments when taken in conjunction with the accompanying drawings, in which:

FIG. 1A depicts a schematic representation of a first non-limiting embodiment, in which there is depicted a method (100) of manufacturing a hot-runner system.

FIG. 1B depicts a schematic representation of a second non-limiting embodiment, in which there is depicted a method (200) of manufacturing a hot-runner system.

FIG. 1C depicts a schematic representation of a third non-limiting embodiment, in which there is depicted a method (300) of manufacturing the hot-runner system.

FIG. 1D depicts a schematic representation of a fourth non-limiting embodiment, in which there is depicted a method (400) of manufacturing the hot-runner system.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE PREFERRED EMBODIMENT(S)

An injection-molding system and a hot-runner system may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9).

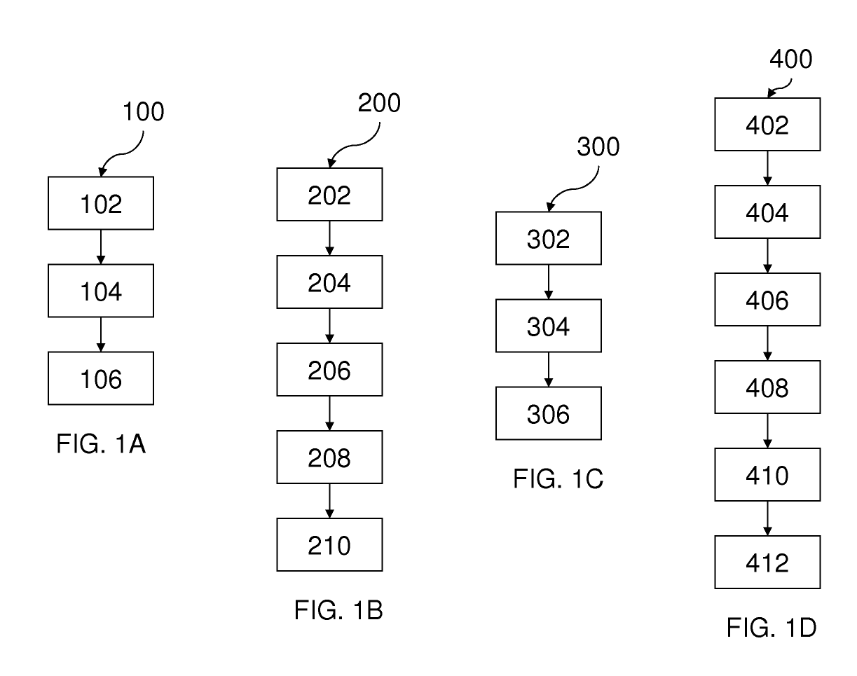

FIG. 1A depicts the schematic representation of the first non-limiting embodiment, in which there is depicted the method (100) of manufacturing the hot-runner system. The method (100) includes (but is not limited to): (i) a preparing operation (102), (ii) a manufacturing operation (104), and (iii) a shipping operation (106). The preparing operation (102) includes (but is not limited to): preparing, at least in part, engineering data related to a partially-completed (partially constructed) hot-runner component. An example of the partially-completed hot-runner component includes (but is not limited to): a partially constructed manifold assembly. The partially-completed hot-runner component is to be used (that is, integrated or included) in the hot-runner system. The preparing operation (102) may also be called an application review process, in which other operations may be included, such as (but not limited to): mold flow analysis, application validation, engineering design, bill of materials (BOM), numerical control (NC) programming During the preparing operation (102) features of the partially-completed hot-runner component are established, such as (but not limited to): location of thermocouples, establishing thermal profile plug details for plugging melt channels, melt channel manufacturing details, manufacturing operations, etc.

The manufacturing operation (104) includes (but is not limited to): manufacturing, at least in part, the partially-completed hot-runner component based on the engineering data related to the partially-completed hot-runner component. It will be appreciated that the vendor entity partially manufactures the partially constructed hot-runner component (such as a manifold system) by using operations, such as (but not limited to): water jetting a manifold configuration (such as outer parameters), gun drilling melt channels, drilling cooling lines, installing thermal couples to nozzles, plugging operation to plug up the melt channel, manufacturing heater grooves, etc.

The shipping operation (106) includes (but is not limited to): shipping the partially constructed hot-runner component, either from inventory or from the assembly line, to a business entity. The business entity is to build, at least in part, the hot-runner system using the partially constructed hot-runner component. The business entity is to ship the hot-runner system to an end user. The end user is to use the hot-runner system in a molding system. It will be appreciated that a vendor entity that executes the method (100) may be a vendor such as (but not limited to): HUSKY Injection Molding Systems Ltd. located in Bolton, Ontario, Canada. It will also be appreciated that the vendor entity and the business entity have reached a legal agreement or contract, which requires: (i) the business entity to receive the partially-completed hot-runner component from the vendor entity, and (ii) the vendor entity receives a financial compensation for having shipped the partially-completed hot-runner component to the business entity.

FIG. 1B depicts the schematic representation of the second non-limiting embodiment, in which there is depicted the method (200) of manufacturing the hot-runner system. The business entity may then execute operations associated with the method (200) after the business entity has received the partially-completed hot-runner component from the vendor entity. The method (200) includes: (but is not limited to): (i) a receiving operation (202), (ii) a placing operation (204), (iii) a removing operation (206), (iv) a manufacturing operation (208), and (v) an assembling operation (210). The receiving operation (202) includes (but is not limited to): receiving, from the vendor entity, the partially-completed hot-runner component. The vendor entity prepares and ships the partially-completed hot-runner component to the business entity. The placing operation (204) includes (but is not limited to): placing the partially-completed hot-runner component in an inventory. The removing operation (206) includes (but is not limited to): removing the partially-completed hot-runner component from inventory after receiving a customer order having requirements. The manufacturing operation (208) includes (but is not limited to): manufacturing, in accordance with the requirements of a sales order from the end user, the partially-completed hot-runner component into a manufactured hot-runner component. Additional manufacturing of the partially-completed hot-runner component includes: finishing the machining of a manifold system, such as (bit not limited to): manufacturing drop location, installing manifold bushing (or a device to direct melt flow in a certain direction), installing heaters, etc. The assembling operation (210) includes (but is not limited to): assembling a completed hot-runner system using the manufactured hot-runner component. The business entity may also execute operations for running tests, such as (bit not limited to): run a heater element test, checks critical dimensions, etc.

A technical effect for the above arrangements is (but is not limited to): shorter lead times for the business entity because business entity can stock standard manifolds, and/or cost savings for the business entity because of the sharing of work/manufacturing operations. It will be appreciated that the engineering details are preferably controlled by the vendor entity.

FIG. 1C depicts the schematic representation of the third non-limiting embodiment, in which there is depicted the method (300) of manufacturing the hot-runner system. In the method (300), the vendor entity supplies standard components of the hot-runner system, such as the drops (nozzles, heaters, actuators) and manifold bushing to the business entity. The method (300) includes (but is not limited to): (i) a preparing operation (302), (ii) a preparation operation (304), and (iii) a shipping operation (306). The preparing operation (302) includes (bit is not limited to): preparing engineering to data related to the hot-runner system. The preparation operation (304) includes (but is not limited to): preparing a standard hot-runner component (such as a drop, a nozzle, a heater, a valve-stem actuator, etc). The standard hot-runner component is to be used in the hot-runner system. The shipping operation (306) includes (but is not limited to): shipping the standard hot-runner component and the engineering data (either from inventory or not) to a business entity. The business entity is to use the standard hot-runner component and the engineering data to build the hot-runner assembly. The business entity is to ship the hot-runner system to an end user of the hot-runner system. The end user is to use the hot-runner system in a molding system.

The method (300) includes having the vendor supply standard components of the hot-runner system, such as (but not limited to) drops, nozzles, heaters, actuators, etc, and the vendor does not perform or execute partial manufacturing of the manifold (as described above in connection with method (100), and the manifold is completed by the business entity.

FIG. 1D depicts the schematic representation of the fourth non-limiting embodiment, in which there is depicted the method (400) of manufacturing a hot-runner system. The business entity may then execute operations associated with the method (400) after the business entity receives the standard hot-runner component and the engineering data from the vendor entity. The method (400) includes (but is not limited to): (i) a receiving operation (402), (ii) a manufacturing operation (404), (iii) a placing operation (406), (iv) a removing operation (408), (iv) a manufacturing operation (410), and (v) a shipping operation (412). The receiving operation (402) includes (but is not limited to) receiving, from the vendor entity, a standard hot-runner component (such as a drop, a nozzle, a heater, a valve-stem actuator, etc). The manufacturing operation (404) includes (but is not limited to) manufacturing a manifold system having the standard hot-runner component. The placing operation (406) includes placing the manifold system in inventory. The removing operation (408) includes (but is not limited to) removing the manifold system from inventory after receiving a customer order having requirements. The manufacturing operation (410) includes (but is not limited to) manufacturing a hot-runner system having the manifold system removed from inventory, in accordance with the requirements of the customer order. The shipping operation (412) includes (but is not limited to): shipping the hot-runner system.

It will be appreciated that, for some examples, the business entity may also be the end user. It will be appreciated that the method (100) and the method (300) may be combined.

It is noted that the foregoing has outlined some of the more pertinent non-limiting embodiments. Thus, although the description is made for particular arrangements and methods, the intent and to concept of the aspects is suitable and applicable to other arrangements and applications. It will be clear to those skilled in the art that modifications to the disclosed embodiments can be effected without departing from the scope the independent claims. It is understood that the described embodiments are merely illustrative of the independent claims.

What is claimed is:

1. A method (100) of manufacturing a hot-runner system, comprising:
a shipping operation (106), including shipping a partially-completed hot-runner component to a business entity, the business entity to build, at least in part, the hot-runner system using the partially-completed hot-runner component, the business entity to ship the hot-runner system to an end user, and the end user to use the hot-runner system in a molding system, the partially-completed hot-runner component being manufactured, at least in part, based on engineering data related to the partially-completed hot-runner component, and the engineering data being prepared, at least in part, the engineering data being related to the partially-completed hot-runner component, the partially-completed hot-runner component to be used in the hot-runner system.

2. A method (100) of manufacturing a hot-runner system, comprising:
a preparing operation (102), including preparing, at least in part, engineering data related to a partially-completed hot-runner component, the partially-completed hot-runner component to be used in the hot-runner system;
a manufacturing operation (104), including manufacturing, at least in part, the partially-completed hot-runner component based on the engineering data related to the partially-completed hot-runner component; and
a shipping operation (106), including shipping the partially-completed hot-runner component to a business entity, the business entity to build, at least in part, the hot-runner system using the partially-completed hot-runner component, the business entity to ship the hot-runner system to an end user, and the end user to use the hot-runner system in a molding system.

3. A method (300) of manufacturing a hot-runner system, comprising:
a shipping operation (306), including: shipping a standard hot-runner component and engineering data to a business entity, the engineering data being prepared is related to the hot-runner system, the standard hot-runner component being prepared is to be used in the hot-runner system, the business entity is to use the standard hot-runner component and the engineering data to build the hot-runner system, the business entity is to ship the hot-runner system to an end user of the hot-runner system, the end user is to use the hot-runner system in a molding system.

4. A method (300) of manufacturing a hot-runner system, comprising:
a preparing operation (302), including: preparing, at least in part, engineering data related to the hot-runner system;
a preparation operation (304), including: preparing, at least in part, a standard hot-runner component, the standard hot-runner component to be used in the hot-runner system; and
a shipping operation (306), including shipping the standard hot-runner component and the engineering data to a business entity, the business entity to use the standard hot-runner component and the engineering data to build the hot-runner system, the business entity to ship the hot-runner system to an end user of the hot-runner system, the end user to use the hot-runner system in a molding system.
